(19) United States
(12) Patent Application Publication
(10) Pub. No.: US 2018/0104798 A1
(43) Pub. Date: Apr. 19, 2018

(54) PIPE FLANGE INSTALLATION AND REMOVAL DEVICE

(71) Applicant: Craig Heigh, Rapid City, SD (US)

(72) Inventor: Craig Heigh, Rapid City, SD (US)

(21) Appl. No.: 15/296,159

(22) Filed: Oct. 18, 2016

(51) Int. Cl. B25B 13/50; B25B 23/00

(52) U.S. Cl. CPC B25B 13/50; B25B 23/0035

(57) ABSTRACT

A pipe flange installation and removal device facilitates installation and removal of a pipe flange from a pipe. The device includes a plate and a connector extending outwardly from a first face of the plate. The connector is configured to be engaged by a tool to rotate the plate. Each of a pair of shafts extends outwardly from a second face of the plate. Each of the shafts is laterally spaced from the connector for insertion through holes extending through a pipe flange to impart rotation to the pipe flange when the plate is rotated.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to flange installation and removal devices and more particularly pertains to a new flange installation and removal device for facilitating installation and removal of a flange from a pipe.

### BRIEF SUMMARY OF THE INVENTION

An embodiment of the disclosure meets the needs presented above by generally comprising a plate and a connector extending outwardly from a first face of the plate. The connector is configured to be engaged by a tool to rotate the plate. Each of a pair of shafts extends outwardly from a second face of the plate. Each of the shafts is laterally spaced from the connector for insertion through holes extending through a pipe flange to impart rotation to the pipe flange when the plate is rotated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a partially exploded top front side perspective view of a pipe flange installation and removal device according to an embodiment of the disclosure.

FIG. 2 is a top view of an embodiment of the disclosure.

FIG. 3 is an exploded top front side perspective view of an embodiment of the disclosure.

FIG. 4 is a back view of an embodiment of the disclosure.

### DETAILED DESCRIPTION OF THE INVENTION

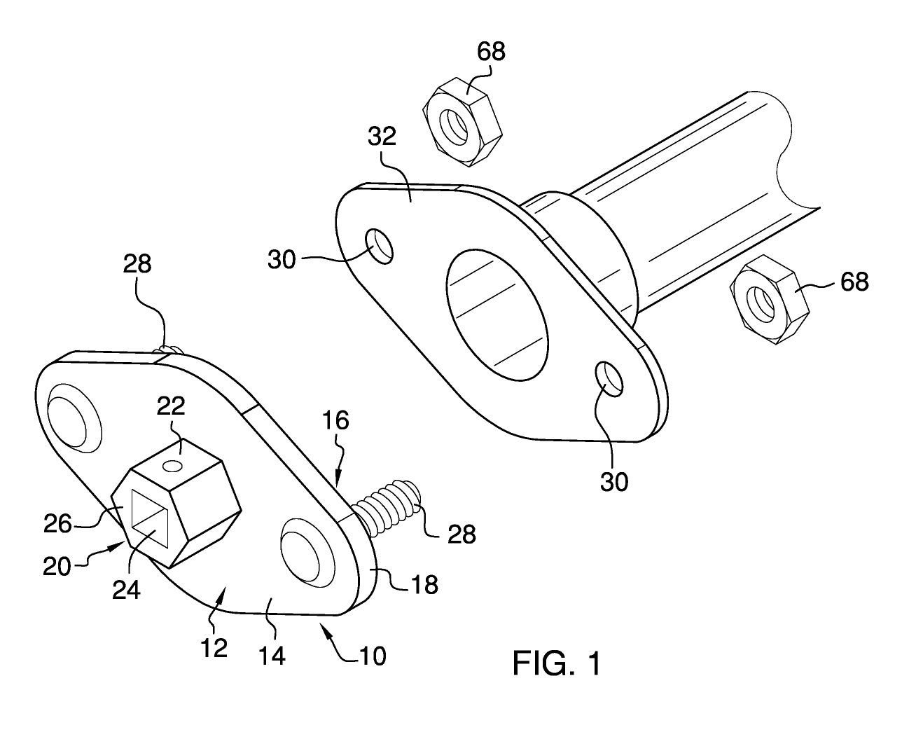

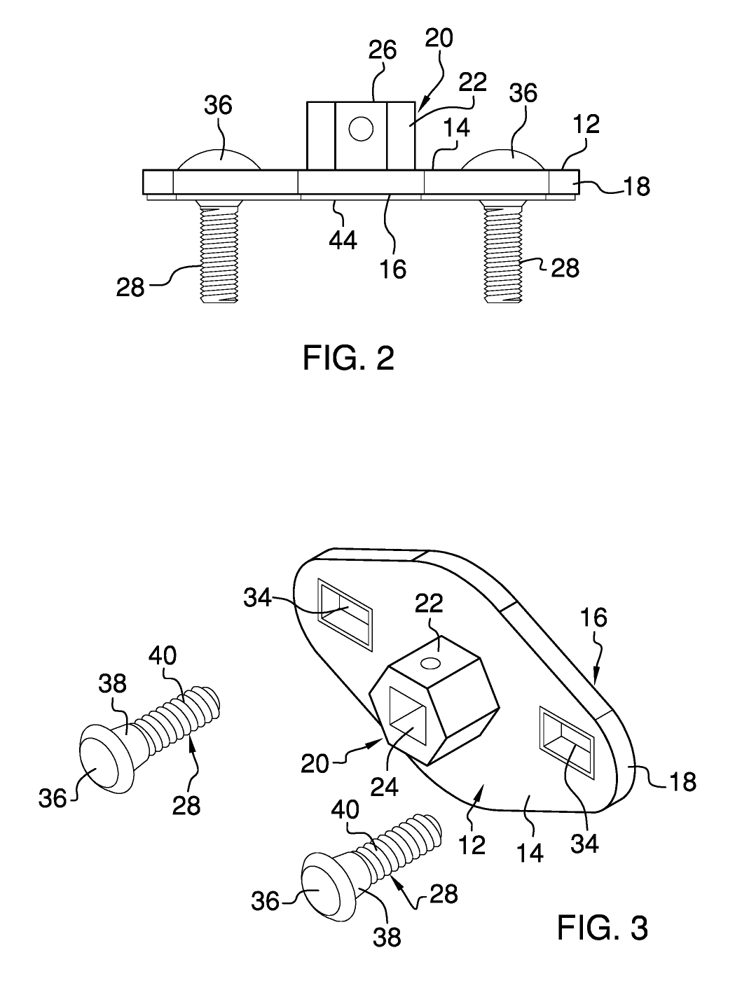

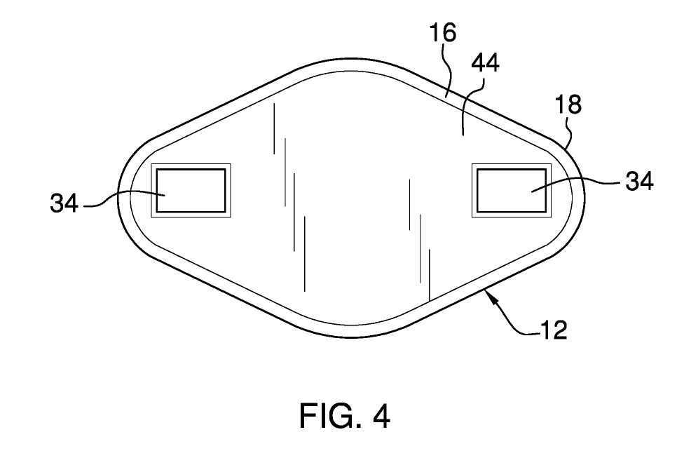

With reference now to the drawings, and in particular to FIGS. 1 through 4 thereof, a new flange installation and removal device embodying the principles and concepts of an embodiment of the disclosure and generally designated by the reference numeral 10 will be described.

As best illustrated in FIGS. 1 through 4, the pipe flange installation and removal device 10 generally comprises a plate 12 having a first face 14, a second face 16, and a peripheral edge 18 extending around and between the first face 14 and the second face 16. A connector 20 extends outwardly from the first face 14. The connector 20 is statically coupled to the plate 12 wherein the connector 20 is configured for being engaged by a driving tool to rotate the plate 12. The connector 20 includes a peripheral wall 22 which is perpendicular relative to the second face 16. The peripheral wall 22 defines a polygonal shape which may more specifically be hexagonal. The connector 20 further includes a drive socket 24 extending into a distal face 26 of the connector 20 relative to the first face 14. The distal face 26 is parallel relative to the second face 16. Thus, the connector 20 may be engaged by a male drive end configured for engaging the drive socket 24.

Each of a pair of shafts 28 extends outwardly from the second face 16 of the plate 12 away from the connector 20. Each of the shafts 28 is laterally spaced from the connector 20 wherein the shafts 28 are configured for insertion through holes 30 extending through a pipe flange 32 to be removed from a pipe. Each of the pair of shafts 28 is coupled to the plate 12 such that the shafts 28 impart rotation to the pipe flange 32 when the plate 12 is rotated. The shafts 28 may be fixedly coupled to the plate 12 or each of the shafts 28 is removably inserted through an associated one of a pair of openings 34 extending through the plate 12. When removable from the plate 12, each shaft 28 has an associated head 36 coupled thereto such that the head 36 prevents the shaft 28 from passing completely through the associated one of the openings 34. Each shaft 28 further has a neck portion 38 positioned between the associated head 36 and a distal section 40 of the shaft 28 relative to the associated head 36. Each neck portion 38 is received in the associated one of the openings 34 when the shaft 28 is fully inserted through the associated one of the openings 34. The neck portion 38 is polygonal to engage the plate 12 and prevent rotation of the shaft 28 in the associated one of the openings 34. The distal section 40 of each shaft 28 may be threaded. Thus, each shaft may be engaged by a respective nut 68 or the like to temporarily secure the plate 12 to the pipe flange 32. Each of the openings 34 is elongated wherein the neck portion 38 of each of the shafts 28 is slidable within the associated one of the openings 34 for adjusting a distance between the shafts 28. Thus, the plate 12 may be engaged to and used to remove a range of sizes of pipe flanges 32. The openings 34 having a common central longitudinal axis and the common central longitudinal axis is aligned with a center of a the connector 20.

A gasket 44 is positioned on the second face 16 of the plate 12 wherein the gasket 44 is configured for abutting the pipe flange 32.

In use, the plate 12 is attached to the pipe flange 32. Mere insertion of the shafts 28 through the pipe flange 32 may be sufficient but the device 10 may be further secured by hand tightening of nuts to the shafts 28 if desired. A desired tool such as a driving tool, ratchet wrench, box wrench, or the like conventionally used with either a conventional nut or socket drive, is engaged to the connector 20. The selected tool is then used to rotate the plate 12 in the desired direction to rotate and either install or remove the pipe flange 32 from the pipe. After installation or removal, the device 10 may be disengaged from the pipe flange 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pipe flange installation and removal device comprising:
a plate having a first face, a second face, and a peripheral edge extending around and between said first face and said second face;
a connector, said connector extending outwardly from said first face, said connector being statically coupled to said plate wherein said connector is configured for being engaged by a tool to rotate said plate; and
a pair of shafts, each of said shafts extending outwardly from said second face of said plate, each of said shafts being laterally spaced from said connector wherein said shafts are configured for insertion through holes extending through a pipe flange, each of said pair of shafts being coupled to said plate such that said shafts are configured to impart rotation to the pipe flange when said plate is rotated.

2. The device of claim 1, further comprising said connector including a peripheral wall being perpendicular relative to said second face.

3. The device of claim 2, further comprising said peripheral wall defining a polygonal shape.

4. The device of claim 2, further comprising said peripheral wall defining a hexagonal shape.

5. The device of claim 1, further comprising said connector including a drive socket extending into a distal face of said connector relative to said first face.

6. The device of claim 1, further comprising:
a pair of openings extending through said plate; and
each of said shafts being removably inserted through an associated one of said pair of openings.

7. The device of claim 6, further comprising each shaft having an associated head coupled to such that said head prevents said shaft from passing completely through said associated one of said openings

8. The device of claim 7, further comprising each said shaft having a neck portion positioned between said associated head and a distal section of said shaft relative to said associated head, each said neck portion being received in said associated one of said openings when said shaft is fully inserted through said associated one of said openings.

9. The device of claim 6, further comprising each of said openings being elongated wherein each of said shafts is slidable within said associated one of said openings for adjusting a distance between said shafts.

10. The device of claim 9, further comprising said openings having a common central longitudinal axis.

11. The device of claim 10, further comprising said common central longitudinal axis being aligned with a center of a said connector.

12. The device of claim 1, further comprising a gasket positioned on said second face of said plate wherein said gasket is configured for abutting the pipe flange.

13. A pipe flange installation and removal device comprising:
a plate having a first face, a second face, and a peripheral edge extending around and between said first face and said second face;
a connector, said connector extending outwardly from said first face, said connector being statically coupled to said plate wherein said connector is configured for being engaged by a tool to rotate said plate, said connector including a peripheral wall being perpendicular relative to said second face, said peripheral wall defining a hexagonal shape, said connector including a drive socket extending into a distal face of said connector relative to said first face;
a pair of openings extending through said plate;
a pair of shafts, each of said shafts extending outwardly from said second face of said plate, each of said shafts being laterally spaced from said connector wherein said shafts are configured for insertion through holes extending through a pipe flange, each of said pair of shafts being coupled to said plate such that said shafts are configured to impart rotation to the pipe flange when said plate is rotated, each of said shafts being removably inserted through an associated one of said pair of openings, each shaft having an associated head coupled to such that said head prevents said shaft from passing completely through said associated one of said openings, each said shaft having a neck portion positioned between said associated head and a distal section of said shaft relative to said associated head, each said neck portion being received in said associated one of said openings when said shaft is fully inserted through said associated one of said openings, each of said openings being elongated wherein each of said shafts is slidable within said associated one of said openings for adjusting a distance between said shafts, said openings having a common central longitudinal axis, said common central longitudinal axis being aligned with a center of a said connector; and
a gasket positioned on said second face of said plate wherein said gasket is configured for abutting the pipe flange.
